(19) United States
(12) Patent Application Publication
(10) Pub. No.: US 2004/0202371 A1
(43) Pub. Date: Oct. 14, 2004

(54) Image processing apparatus that decomposes an image into components of different properties

(76) Inventors: Taku Kodama, Kanagawa (JP); Junichi Hara, Kanagawa (JP); Yasuyuki Nomizu, Kanagawa (JP); Toshio Miyazawa, Kanagawa (JP); Takanori Yano, Kanagawa (JP); Yasuyuki Shinkai, Kanagawa (JP); Nekka Matsuura, Kanagawa (JP); Hiroyuki Sakuyama, Tokyo (JP); Takayuki Nishimura, Tottori (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/763,882

(22) Filed: Jan. 23, 2004

(30) Foreign Application Priority Data
Jan. 23, 2003 (JP) 2003-014873
Jan. 22, 2004 (JP) 2004-014932

(51) Int. Cl. G06K 9/36

(52) U.S. Cl. 382/232

(57) ABSTRACT

An image processing apparatus is disclosed, including: a dividing unit, a generating unit, an encoding unit, and a combining unit. The dividing unit divides the image into regions based on a division signal, where the division signal indicates image regions of an image. The generating unit generates components corresponding to the regions divided by the dividing unit. Each component is independently encoded by the encoding unit, and is combined into the codestream by the combining unit.

The present application claims priority to the corresponding Japanese Application Nos. 2003-014873, filed on Jan. 23, 2003 and 2004-014932, filed on Jan. 22, 2004, the entire contents of which are hereby incorporated by reference.

### BACKGROUND OF THE INVENTION

1. Field of the Invention

The present invention generally relates to an image processing apparatus, and more particularly, to an image processing apparatus that, before processing, decomposes an image into components of different properties.

The present invention further relates to an image forming apparatus in which the image processing apparatus is built, a method of processing an image in which the image is decomposed into components of different properties, a computer program that causes a computer to function as the image processing apparatus, and a recording medium storing the computer program.

2. Description of the Related Art

JPEG 2000 has been internationally standardized as an algorithm for compressing and decompressing images. JPEG 2000 usually decomposes an image into multiple components, and divides each component into multiple rectangular regions (tiles). Each tile is encoded independently. An image can be decomposed into at most 256 components. The image, however, is often decomposed into three components corresponding to colors such as red (R), green (G), and blue (B).

Japanese Laid-Open Patent Application No. 2001-217718 discloses a method of encoding an image by dividing the image into tiles and transforming the tiles into wavelet coefficients with a 2-dimensional wavelet transform.

An image is usually composed of portions including text, drawings, pictures, and a background, for example. If the image is decomposed into components of different colors, each component includes the text portion, the drawing portion, the picture portion, and the background portion. The portions of the image are different in properties and purposes. For example, when the image is encoded in lossy mode and then decoded, the portions of the image may be equally degraded. A user (observer) usually recognizes the degrading of text portions, but may not notice the degrading of picture portions. The degrading of text portions is usually more apparent than the degrading of picture portions.

As described above, if the portions of different properties and purposes are included in a component and are equally encoded, the decoded image includes both portions in which the effect of encoding is apparent and other portions in which the effect of encoding is not so apparent.

Additionally, if the user desires to separately print only a picture portion included in the image, all components need to be decoded, and then, the picture portion is printed.

If the image is decomposed into portions of different properties and purposes, and is encoded in consideration of the difference in properties and purposes, the encoding of the image becomes more efficient, and the image becomes easy to handle. If the image includes a specific portion designated as a Region of Interest (ROI), and the ROI is handled as a component, the user can use the ROI more effectively.

### SUMMARY OF THE INVENTION

An image processing technique that decomposes an image into components of different properties is described. In one embodiment, an image processing apparatus comprises: a dividing unit that divides an image into a plurality of regions based on a division signal; a generating unit that generates components of the respective divided regions; an encoding unit that encodes the generated components; and a combining unit that combines the encoded components into a codestream.

### BRIEF DESCRIPTION OF THE DRAWINGS

FIG. 1 is a block diagram showing the JPEG 2000 algorithm;

FIG. 2 is a schematic diagram showing a color image decomposed into components, wherein each component is divided into multiple rectangular regions;

FIG. 3 is a data diagram showing the structure of a codestream of JPEG 2000;

FIG. 4 is a block diagram showing the structure of an image forming apparatus according to one embodiment;

FIG. 5 is a block diagram showing the structure of the encoder of the image forming apparatus according to one embodiment;

FIG. 6 is a schematic diagram for illustrating the decomposing of the image into components according to one embodiment;

FIG. 7 is a block diagram showing a variation of the structure of the encoder of the image forming apparatus according to an embodiment;

FIG. 8 is a block diagram showing another variation of the structure of the encoder of the image forming apparatus according to another embodiment;

FIG. 9 is a flowchart showing the operation of the encoder shown in FIG. 5;

FIG. 10 is a flowchart showing the operation of the encoder shown in FIG. 7;

FIG. 11 is a flowchart showing the operation of the encoder shown in FIG. 8; and

FIG. 12 is a block diagram showing the structure of an information processing apparatus according to one embodiment of the present invention.

### DETAILED DESCRIPTION OF THE PREFERRED EMBODIMENTS

One or more embodiments of the present invention include a novel and useful image processing apparatus in which at least one of the above problems is eliminated.

Another and more specific embodiment of the present invention comprises an image processing apparatus that can efficiently encode an image and makes the image easy to use by decomposing the image into portions of different properties and purposes.

Yet another embodiment of the present invention comprises an image processing apparatus that uses encoding methods suitable for each component to be encoded.

In at least one of the above embodiments, an image processing apparatus according to one embodiment of the present invention includes: a dividing unit that divides an image into regions based on a division signal; a generating unit that generates components of the respective divided regions; an encoding unit that encodes the generated components; and a combining unit that combines the encoded components into a codestream.

The dividing unit divides the image into regions based on the division signal, where the division signal indicates image regions of the image. The generating unit generates components corresponding to the regions divided by the dividing unit. Each component is independently encoded by the encoding unit, and is combined into the codestream by the combining unit.

Other embodiments, features, and advantages of the present invention will become more apparent from the following detailed description when read in conjunction with the accompanying drawings.

The preferred embodiments are described below with reference to the drawings.

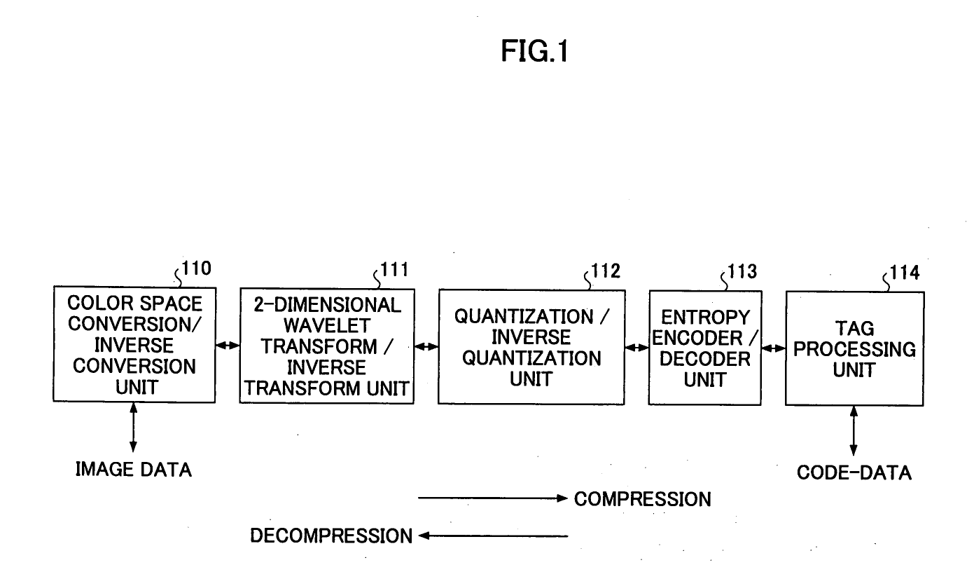

FIG. 1 is a block diagram showing the JPEG 2000 algorithm. The JPEG 2000 algorithm includes the following: a color space conversion/inverse conversion unit 110, a 2-dimensional wavelet transform/inverse transform unit 111, a quantization/inverse quantization unit 112, an entropy encoding/decoding unit 113, and a tag unit 114.

The color space conversion (inverse conversion) unit 110 is often provided as the first (last) unit to (from) which the image data are input (output). When the image data are represented in the primary color space of red (R), green (G), and blue (B), or in the complementary color space of yellow (Y), magenta (M), and cyan (C), the color space conversion unit 110 converts the image data into that represented in the YCrCb color space or the YUV color space.

The JPEG 2000 algorithm is defined in JPEG 2000, Part I, International Standard, the entire contents of which are hereby incorporated by reference.

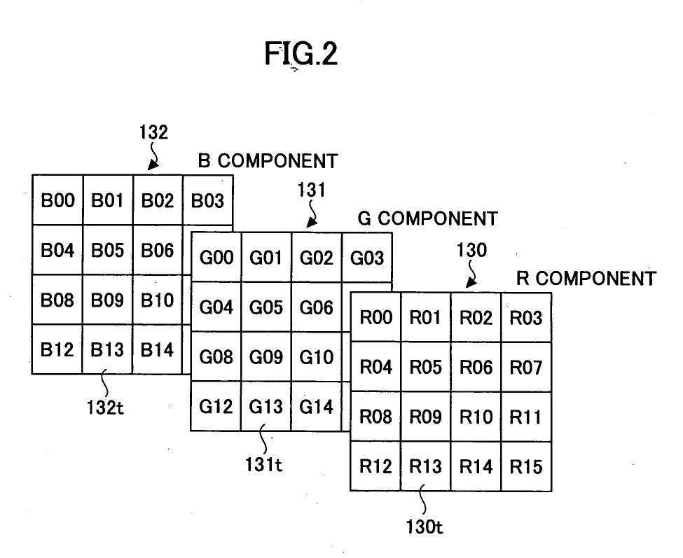

FIG. 2 is a schematic diagram showing a color image decomposed into color components, wherein each color component is further divided into tiles. Generally, the color image is decomposed into the color components 130, 131, and 132 corresponding to RGB, for example. Each color component is further divided into multiple rectangular regions (tiles) 130ₜ, 131ₜ, and 132ₜ. Tiles R00, R01, . . . , R15, G00, G01, . . . , G15, B00, B01, . . . , B15 are encoded independently from each other.

The tiles are input to the color space conversion unit 110 shown in FIG. 1, and the color space of the tiles is converted. Then, the tiles are input to the 2-dimensional wavelet transform unit 111, and are transformed with 2-dimensional wavelet transform (forward transform) into frequency domains.

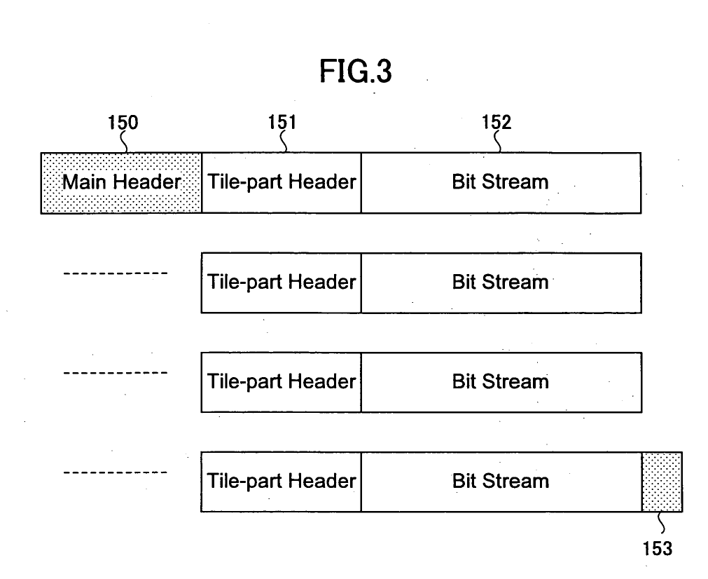

As a result of the encoding of the image data with the JPEG 2000 algorithm, the image data are converted into a codestream. FIG. 3 is a data diagram showing the structure of a codestream. Each tile of the image data is converted into a bit stream 152 (code data). A tile-part header 151 is attached to each bit stream 152. The tile-part headers 151 and the bit streams 152 combined with each other constitute a codestream. A main header 150 and an EOC (End Of Codestream) marker 153 are attached to the codestream at the head and the tail thereof, respectively.

When the codestream is decoded, each bit stream 152 is decoded into a tile, and the tiles make a component. Then, the components make the image.

The encoding and decoding of a usual (single) still image are described above. JPEG 2000 is also applicable to a motion picture by regarding each frame of the motion picture as a still image. The motion picture is a set of still images that are encoded and decoded at a suitable frame speed in this case. This technique is referred to as the motion encoding and decoding of still images. The motion encoding and decoding of still images is advantageous in some embodiments when compared to MPEG that is widely used for compressing video signals. For example, each frame produced by the motion encoding and decoding is a still image of high quality. It is expected that the motion encoding and decoding will first be used for business by broadcasters, and then, pervade to consumers.

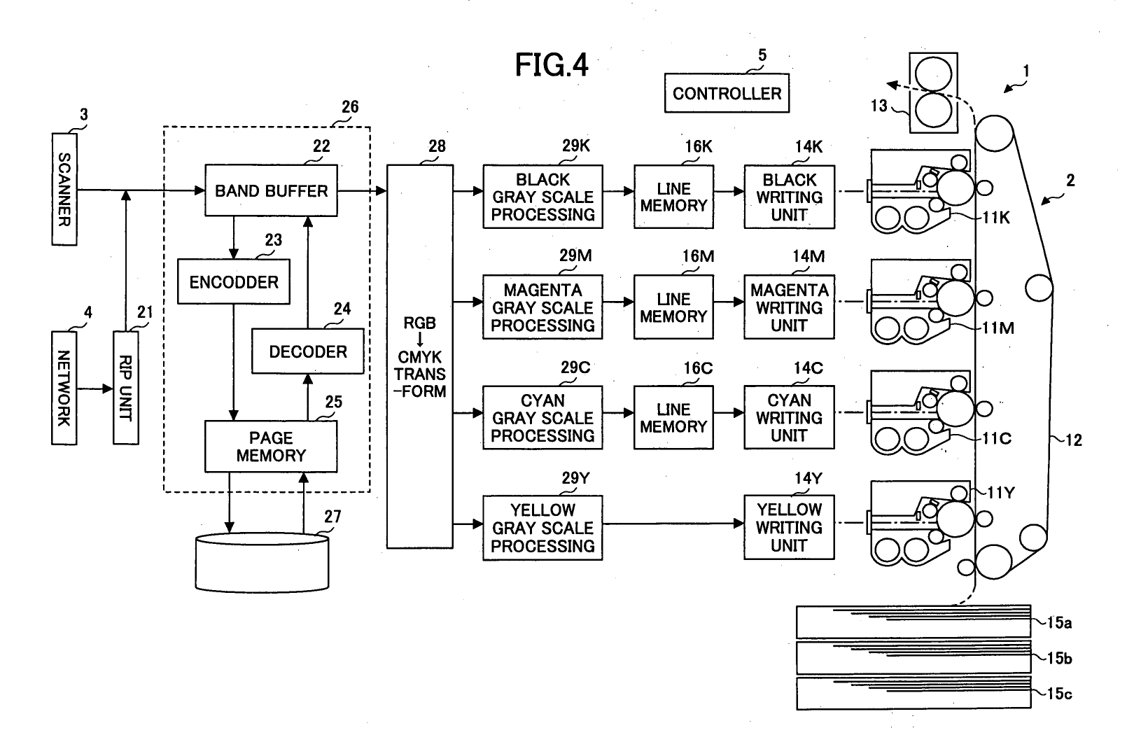

FIG. 4 is a block diagram showing the structure of a digital copier 1 according to one embodiment. The digital copier 1 is an embodiment of the image forming apparatus according to the present invention. The digital copier 1 includes a printer engine 2 for forming an image on paper through an electrophotography process known in the art, for example, and a scanner 3 for reading an image of a document. The digital copier 1 is controlled by controllers including a main controller for controlling the entire system of the digital copier 1 and multiple sub-controllers for controlling portions of the digital copier 1 under the control of the main controller. The controller 5 shown in FIG. 4 represents all controllers provided in the digital copier 1.

The printer engine 2 includes a photosensitive unit, a development unit, a cleaning unit, and a charging unit, which are not shown. The printer engine 2 further includes process cartridges 11K, 11M, 11C, and 11Y for forming dry toner images of colors such as black (K), magenta (M), cyan (C), and yellow (Y), respectively. The printer engine 2 further includes a transfer belt 12, a fixing unit 13, and optical writing units 14K, 14M, 14C, and 14Y for writing latent images of respective colors on the photosensitive units provided to the process cartridges 11K, 11M, 11C, and 11Y. The digital copier 1 further includes paper feed trays 15a-15c for storing a recording medium, such as paper and plastic film for an overhead projector, for forming a color image thereon. The process cartridges 11K, 11M, 11C, and 11Y form a color image by superposing toner images of respective colors on the transfer belt 12. The superposed toner images are transferred to the recording medium fed from the paper feed trays 15a-15c, and fixed on the recording medium by the fixing unit 13.

The digital copier 1 includes an image processing apparatus 26 having a controller (not shown), a band buffer 22, an encoder 23, a decoder 24, and a page memory 25.

The band buffer 22 is a buffer for storing pixel data included in one of multiple bands constituting image data to be printed on a sheet of paper. The band is a region of an image including multiple pixel lines.

The digital copier 1 receives image data from an external resource connected via a network 4 and a communication interface (not shown). When image data received from the external resource via the network 4 are written in the page description language (PDL), a RIP unit 21 converts the image data into bit map data by the bands, and outputs the bit map data to the image processing apparatus 26.

The encoder 23 encodes the image data stored in the band buffer 22. The encoded image data (code data) are stored in the page memory 25 (described below). The decoder 24 decodes code data stored in the page memory 25. According to one embodiment, the encoder 23 encodes image data using JPEG 2000, the international standard for encoding still images for compressing them. The encoder 23 hierarchically encodes the image as a whole or encodes each rectangular region (tile) independently by dividing the image into multiple rectangular regions (tiles).

The page memory 25 stores code data into which the image data to be printed on one or more sheets of paper are encoded. It is assumed, however, that the page memory 25 stores the code data of image data for one sheet of paper. The hard disk drive (HDD) 27 receives and stores the code data from the page memory 25 and, when requested, retrieves and transmits the code data to the page memory 25.

A RGB->CMYK transform unit 28 receives image data represented in red (R), green (G), and blue (B) from the band buffer 22 by bands, and transforms the image data into image data represented in cyan (C), magenta (M), yellow (Y), and black (K).

A black gray scale processing unit 29K, a magenta gray scale processing unit 29M, a cyan gray scale processing unit 29C, and a yellow gray scale processing unit 29Y reduce the gray scale of multi-level data of respective colors. For example, 8-bit image data of 600 dpi resolution stored in the band buffer 22 are transformed into 1-bit image data of 1200 dpi by the gray scale processing units 29K, 29M, 29C, and 29Y.

The transformed image data (write data) of black color, magenta color, and cyan color are temporarily stored in line memories 16K, 16M, and 16C, respectively, for the timely forming of images. The respective write data are transferred to a black writing unit 14K, a magenta writing unit 14M, a cyan writing unit 14C, and a yellow writing unit 14Y at timing in which images are superposed.

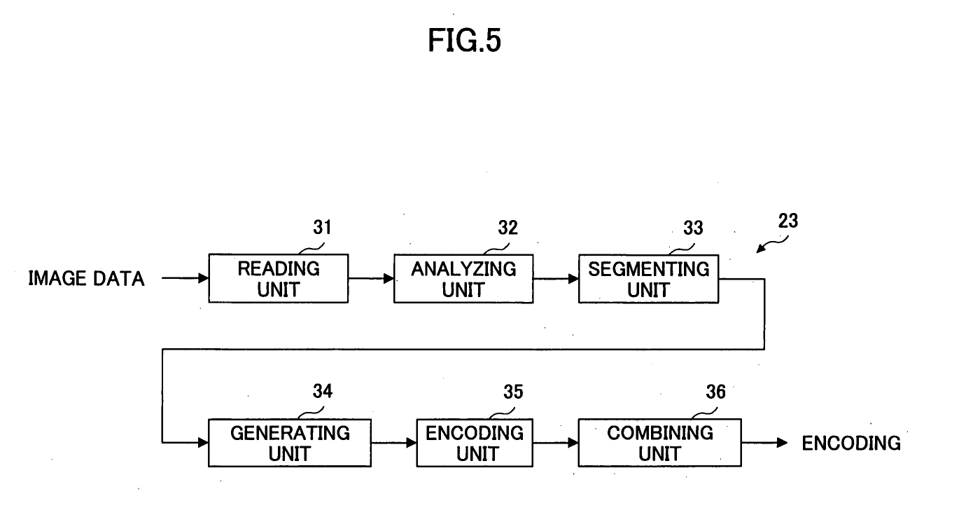

FIG. 5 is a block diagram showing the basic operation of the encoder 23 of the digital copier 1. A reading unit 31 reads the image data of a band from the band buffer 22. An encoding unit 35 divides the image data read by the reading unit 31 into multiple tiles, and hierarchically encodes each tile independently into code data in accordance with JPEG 2000. The encoding unit 35 may encode the image data read by the reading unit 31 as a whole. A combining unit 36 combines multiple items of the code data generated by the encoding unit 35 into a codestream.

An analyzing unit 32 and a segmenting unit 33 process the image data read by the reading unit 31 and to be encoded by the encoding unit 35 in the following manner. The analyzing unit 32 analyzes the image data read by the reading unit 31, and determines how the image data are to be divided. For example, the analyzing unit 32 identifies a text region, a drawing region, a picture region, and a background of the image data. The segmenting unit 33 segments the image data into the text region, the drawing region, the picture region, and the background based on the identification made by the analyzing unit 32. The image data may be segmented as a whole, or by a tile, a precinct, or a code block.

A generating unit 34 generates a component based on each segmented region. The components are independent from each other.

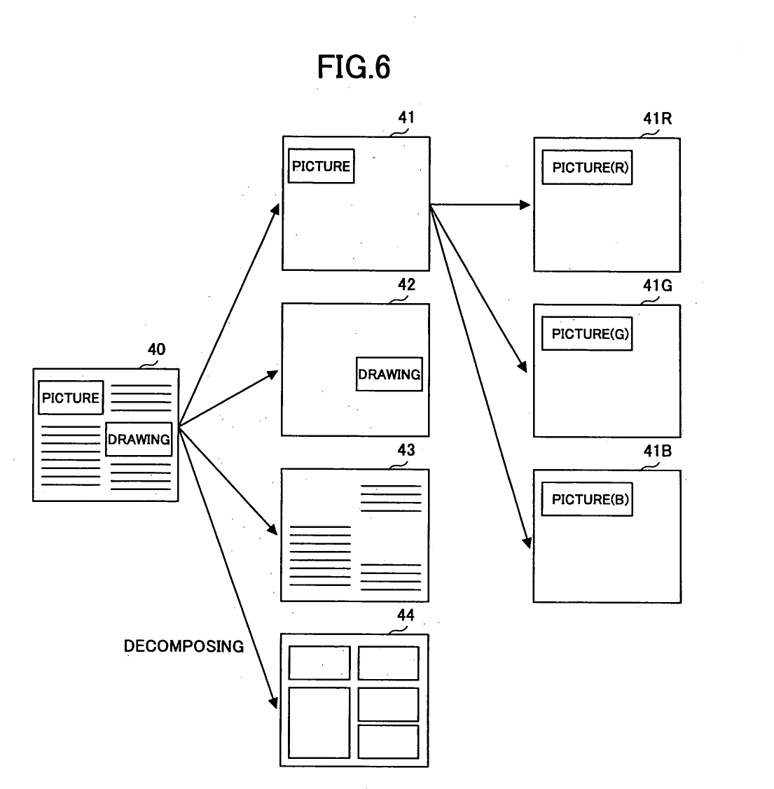

FIG. 6 is a schematic diagram for illustrating the decomposing of the image into components. An image 40 shown in FIG. 6 includes a picture region, a drawing region, text regions, and a background region. The analyzing unit 32 analyzes the image 40 as a whole to identify the regions, and the segmenting unit 33 segments the identified regions. Then, the generating unit 34 generates four components 41 through 44 corresponding to the segmented regions. The picture component 41 corresponds to the picture region included in the image 40. The drawing component 42 corresponds to the drawing region included in the image 40. The text component 43 corresponds to the text region included in the image 40. The background component 44 corresponds to the background region (the remaining region after the picture region, the drawing region, and the text region are removed) of the image 40. Since the picture component 41 includes a color picture, the picture component 41 is decomposed into color components such as red (R), green (G), and blue (B).

The encoding unit 35 encodes the components generated by the generating unit 34 into code data. The encoding unit 35 may encode the components using different encoding methods. For example, the text component 43 may be encoded without being quantized, and the picture data 41 may be encoded being quantized. The encoding unit 35 may encode the components at different quantization ratios. For example, since the text component 43 is easily degraded as the quantization ratio is increased, the text component 43 may need to be encoded at a low quantization ratio. The picture component 41, however, is relatively not easily degraded even when the quantization ratio is increased, so the picture component 41 may be encoded at a high quantization ratio. The drawing component 42 may need to be encoded at a medium quantization ratio.

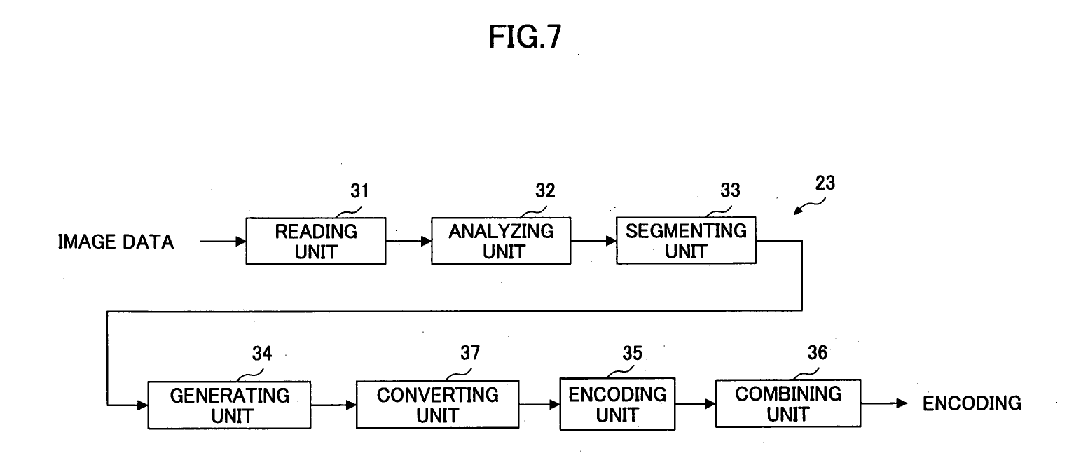

As shown in FIG. 7, a converting unit 37 that converts the data format of the components may be provided between the generating unit 34 and the encoding unit 35. The converting unit 37 converts the data format of the components and makes the data format of a component from the data format of another component. For example, the converting unit 37 may convert the data formats of the text region 43 and the drawing region 42 into binary data, and the data format of the picture region 41 into multi-level data (8-bit data, for example).

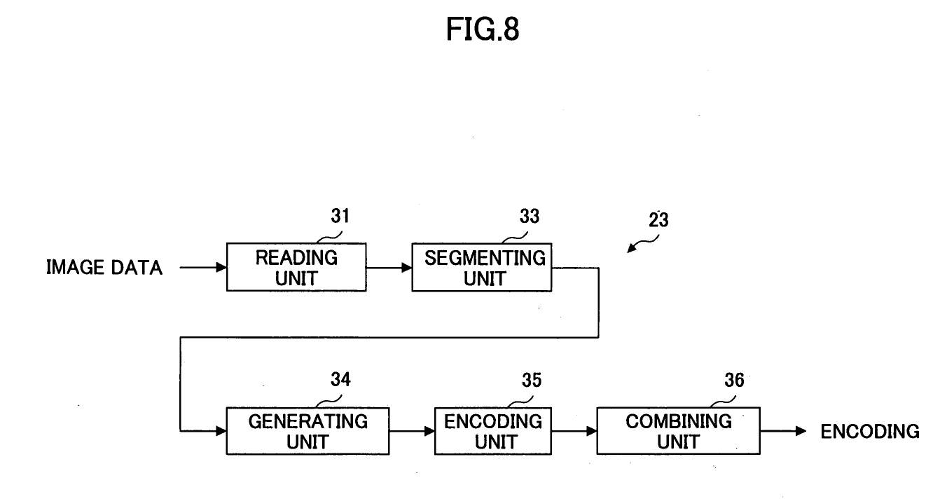

As shown in FIG. 8, the segmenting unit 33 may segment the image without using the analyzing unit 32. For example, if a specific region is designated (a Region Of Interest, or ROI, for example) in the image, the segmenting unit 33 can segment the image into the specific region and the remaining region other than the specific region.

The operation of the encoder 23 may be realized by dedicated hardware and the controller 5. According to another embodiment, the entire operation of the encoder 23 may be realized by the controller 5.

The operation of the encoder 23 shown in FIGS. 5, 7, and 8 is described below.

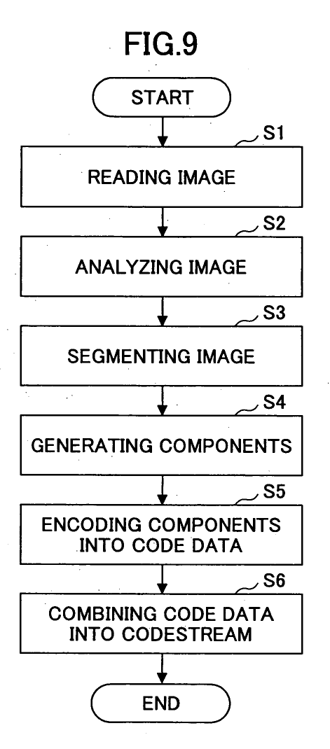

FIG. 9 is a flowchart showing the operation of the encoder 23 shown in FIG. 5. The reading unit 31 reads the image (step S1). The analyzing unit 32 analyzes the image read by the reading unit 31, and identifies the regions (step S2). The segmenting unit 33 segments (divides) the image into regions using the result of the analysis of the analyzing unit 32 (step S3). The generating unit 34 generates a component corresponding to each region (step S4). The encoding unit 35 encodes each component using different encoding methods (step S5). The combining unit 36 combines code data into the codestream (step S6).

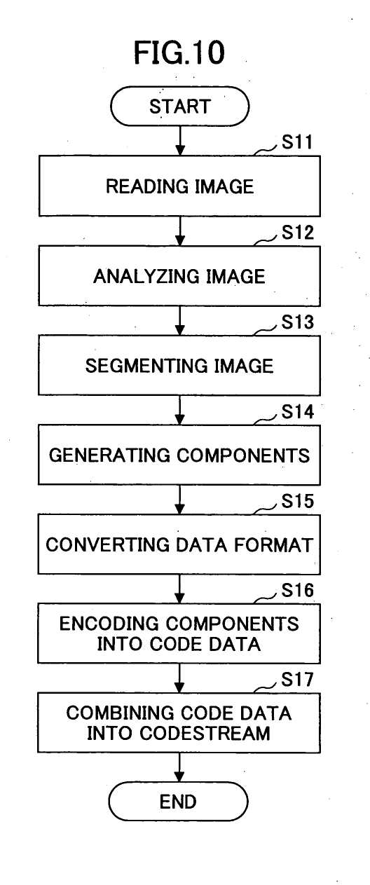

FIG. 10 is a flowchart showing the operation of the encoder 23 shown in FIG. 7. The reading unit 31 reads the image (step S11). The analyzing unit 32 analyzes the image read by the reading unit 31, and identifies the regions (step S12). The segmenting unit 33 segments (divides) the image into the identified regions using the result of the analysis of the analyzing unit 32 (step S113). The generating unit 34 generates the components corresponding to respective regions (step S14). The data formats of the components are made different from each other by the converting unit 37 (step S15). The encoding unit 35 encodes the components of different data formats using the same encoding method (step S16). And then, the combining unit 36 combines the code data into the codestream (step S17).

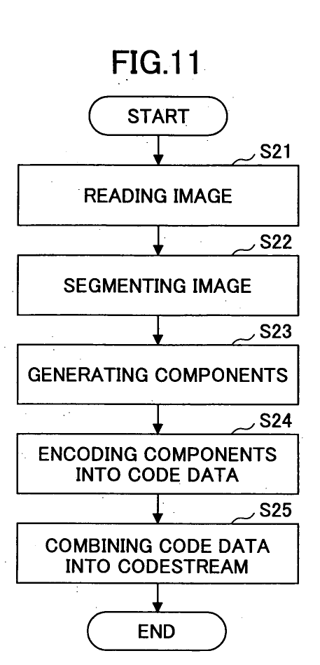

FIG. 11 is a flowchart showing the operation of the encoder 23 shown in FIG. 8. The reading unit 31 reads the image (step S21). No analyzing unit 32 is provided in the encoder 23 shown in FIG. 8, but the specific region is designated in the image data. The segmenting unit 33 segments (divides) the image into the specific region and the remaining region other than the specific region, for example (step S22). The generating unit 34 generates components corresponding to respective regions (step S23). The encoding unit 35 encodes components using encoding methods different component by component (step S24). The combining unit 36 combines code data into the codestream (step S25). According to another embodiment, the data formats of the components may be made different from each other by the converting unit 37, and the encoding unit 35 may encode the components of different data formats using the same encoding method.

As described above, the digital copier 1 that is an embodiment of the image forming apparatus according to one embodiment of the present invention can divide the different regions of an image into respective components (steps S4, S14, and S23), and encodes the components into code data (steps S5, S16, and S24). Accordingly, the image forming apparatus according to one embodiment can efficiently encode an image, and make the encoded image useful.

The image forming apparatus according to one embodiment can encode the image region by region (component by component) with a suitable encoding method (steps S5 and S24), and can encode the image after converting a data format suitable for each region (component) (step S16).

Another embodiment of the present invention is described below with reference to the drawings.

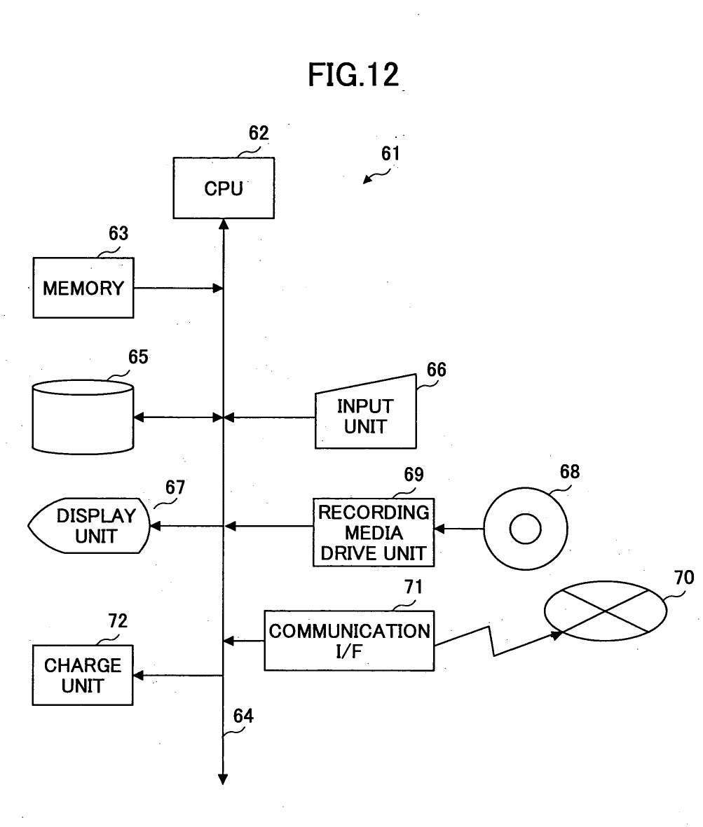

FIG. 12 is a block diagram showing the structure of an image processing apparatus 61 according to one embodiment. As shown in FIG. 12, the image processing apparatus is an information processing apparatus such as a PC. The image processing apparatus 61 includes a CPU 62 that centrally controls the entire system of the image processing apparatus 61 and memory 63 including ROM and RAM, for example, connected by a bus 64.

The following devices may be connected to the bus 64 via respective interface: a magnetic storage device 65 such as a hard disk drive, an input device 66 such as a mouse and a keyboard, a display unit 67 such as an LCD and a CRT, a recording media drive unit 69 for writing and reading data to/from a recording medium 68 such as an optical disk, and a communication interface 71 for communicating with an external source via the network 70 such as the Internet. The recording medium 68 may be an optical disk such as a CD and a DVD, a magneto-optical disk, and a flexible disk, for example. The recording media drive unit 69 may be an optical disk drive, a magneto-optical disk drive, and a flexible disk drive, depending on the recording medium 68.

The magnetic storage device 65 stores an image processing program that realizes a computer program according to an embodiment of the present invention. The image processing program may be read from the recording medium 68 by the recording media drive unit 69, and be installed in the magnetic storage device 65. According to another embodiment, the image processing program may be downloaded from the network 70, and is installed in the magnetic storage device 65. The image processing apparatus 61 runs the installed image processing program. The image processing program may be a computer program that runs on an operating system, or a computer program included in an application program.

The image processing apparatus 61 that executes the image processing program thereon operates in the same manner as the image processing apparatus 26 does. The image processing program realizes processing of both the encoder 23 and the decoder 24. Since the processing contents of the image processing program are the same as those described with reference to FIGS. 5, 7, and 8, the description of processing of the image processing program is omitted.

The image processing apparatus 61 according to one embodiment described with reference to FIGS. 8 and 11, for example, may be provided with a charge unit 72. The image processing apparatus 61 displays only the remaining region of an image other than a specific region (the ROI, for example) on the display unit 67, and may display the specific region of the image subject to a charge of a certain amount being made by the charge unit 72. Such an arrangement is easy for the image processing apparatus 61 according to one embodiment since the image is decomposed into different components corresponding to the specific region and the remaining region of the image other than the specific region.

According to another embodiment, the upper layers of the codestream and the lower layers of the codestream may correspond to different components, respectively. In this case, the image processing apparatus displays only the lower layers before a charge of a certain amount is made by the charge unit 72, and the upper layers may be displayed subject to the charge being made.

The present invention is not limited to these embodiments, but variations may be made without departing from the scope of the present invention.

This patent application is based on Japanese Priority Patent Applications No. 2003-014873, filed on Jan. 23, 2003 and 2004-014932, filed on Jan. 22, 2004, the entire contents of which are hereby incorporated by reference.

What is claimed is:

1. An image processing apparatus, comprising:
a dividing unit to divide an image into a plurality of regions based on a division signal;
a generating unit to generate components of the respective divided regions;
an encoding unit to encode the generated components; and
a combining unit to combine the encoded components into a codestream.

2. The image processing apparatus as claimed in claim 1, wherein
the encoding unit encodes the generated components using different encoding methods.

3. The image processing apparatus as claimed in claim 1, wherein
the encoding unit encodes the generated components using different levels of quantization.

4. The image processing apparatus as claimed in claim 1, further comprising:
a converting unit to change the data format of the generated component prior to the encoding of the generated component.

5. The image processing apparatus as claimed in claim 1, wherein the dividing unit divides the image into a region of interest and the other region.

6. The image processing apparatus as claimed in claim 1, wherein the dividing unit divides the image into at least two of a text region, a drawing region, a photograph region, and a background region based on the division signal.

7. The image processing apparatus as claimed in claim 1, further comprising:
a recognizing unit to recognize the regions of the image, generate the division signal based on the recognition, and transmit the generated division signal to the dividing unit.

8. An image forming apparatus, comprising:
the image processing apparatus that encodes an image into a codestream, when the image processing apparatus comprises a dividing unit to divide an image into a plurality of regions based on a division signal, a generating unit to generate components of the respective divided regions, an encoding unit to encode the generated components, and a combining unit to combine the encoded components into a codestream,
a storing unit to store the codestream;
an image decoding apparatus to decode the codestream stored in the storing unit into the image; and
an image forming unit to form the decoded image.

9. A method of processing an image, comprising:
dividing an image into a plurality of regions based on a division signal;
generating components of the respective divided regions;
encoding the generated components; and
combining the encoded components into a codestream.

10. An article of manufacture having one or more recordable medium storing instructions which, when executed by a computer, cause the computer to perform a method comprising:
dividing an image into a plurality of regions based on a division signal;
generating components of the respective divided regions;
encoding the generated components; and
combining the encoded components into a codestream.

11. The article of manufacture as claimed in claim 10, wherein
encoding the encoded components comprises encoding the generated components using different encoding methods.

12. The article of manufacture as claimed in claim 10, wherein
encoding the encoded components comprises encoding the generated components using different levels of quantization.

13. The article of manufacture as claimed in claim 10, wherein the method further comprises:
changing the data format of the generated component prior to the encoding of the generated component.

14. The article of manufacture as claimed in claim 10, wherein
dividing the image comprises dividing the image into a region of interest and the other region.

15. The article of manufacture as claimed in claim 10, wherein
dividing the image comprises dividing the image into at least two of a text region, a drawing region, a photograph region, and a background region based on the division signal.

16. The article of manufacture as claimed in claim 10, wherein the method further comprises:
recognizing the regions of the image, generating the division signal based on the recognition, and transmitting the generated division signal to the dividing unit.
